(19) United States
(12) Patent Application Publication
(10) Pub. No.: US 2010/0143016 A1
(43) Pub. Date: Jun. 10, 2010

(54) METHOD AND APPARATUS FOR PRINTING A PAMPHLET-LIKE OBJECT IN A PRINTING STATION

(76) Inventors: Elmar Fähnle, Elchingen (DE); Chistian Golde, Weibenhorn (DE); Franz Rauch, Siegertsbrunn (DE); Bernhard Johannes Kistner, Munchen (DE); Christian Ries, Munchen (DE)

Correspondence Address: Setter Roche LLP, P.O. Box 780, Erie, CO, 80516, US

(21) Appl. No.: 12/516,537

(22) PCT Filed: Nov. 27, 2007
(86) PCT No.: PCT/EP07/10300

§ 371 Date: Jan. 25, 2010

(30) Foreign Application Priority Data
Nov. 27, 2006 (DE) 10 2006 055 896.0

(51) Int. Cl. B41J 3/28

(52) U.S. Cl. 400/24

(57) ABSTRACT

The present invention relates to a method and an apparatus for imprinting a booklet-like object in a printing station.

In order to develop a method and apparatus of the above type while reducing method steps and simplifying a structure of a corresponding apparatus, it is proposed that a booklet-like object (2) is inserted in an opened state into a drawer (3) and fed to a printing mechanism of a standard printer and is covered with a printing mask (6) and pressed into a new defined printing plane, wherein the new printing plane is created using a spacer element (5).

### FIELD OF THE INVENTION

The present invention relates to a method and an apparatus for imprinting a booklet-like object in a printing station.

### BACKGROUND OF THE INVENTION

Without limiting the area of application, the following will deal only with the treatment of a booklet-like object in the form of a security document and in particular in the form of a passport document in order to present the invention. According to the prior art, at least one apparatus for printing, embossing, punching, lasing or for implementing one or more similar methods is provided for applying at least one of a plurality of different information and/or security features on, to and/or in a security document. Furthermore, these apparatuses are hereinafter collectively referred to by the term “printing station” without limiting the invention. Modular and self-contained apparatuses for preparing security documents are known from a plurality of printed publications, such as DE 199 56 712 C2, for example. Here at least one printing station is used together with positioning as well as transport and storage apparatuses. Such systems generally print and produce safety documents while being monitored by a computing unit as a control unit. What all known systems have in common is that a completely finished and also personalized safety document is output which, in a respectively predetermined extent, is provided with data and information regarding a particular person and which is made secure against forgery and/or falsification.

Because of, among other things, frequently encountered cramped surroundings, an increased demand for printing stations in the form of smaller, compact-build systems can be observed. By way of example, reference is made to the conditions in departments issuing identification documents or travel documents in embassies and consulate generals. As is known, corresponding booklet-like security documents are structured such that, as a rule, only one double page is imprinted at least partially, in particular with an image or other personal data of the prospective bearer of various types in a form that is readable for people and/or machines being inserted. A prefabricated object that is bound in a book-like manner and which is to be individualized with personal data is therefore fed into a printing station in an opened position, as a rule. Such a printing station therefore comprises, among other things, all required positioning and transporting apparatuses in a largely enclosed housing, wherein a page-turning device, for example, can be omitted as a rule.

Such a printing station for a book-like bound object is known, inter alia, from EP 1 520 715 A1. In order to ensure exact positioning of the book opened in one plane in a simple manner, independent of which page of the book is to be imprinted, numerous separately driven clamping means are provided herein which contact the edge areas of the opened document pages that lie substantially within one plane.

It is the object of the present invention to develop a method and an apparatus of the aforementioned kind while reducing method steps and substantially simplifying the structure of a corresponding apparatus.

### SUMMARY OF THE INVENTION

Accordingly, a method according to the invention is characterized by a booklet-like object being inserted in an opened state into a drawer and fed to a printing mechanism of a standard printer, wherein a new defined printing plane is created using a spacer element.

Within the context of the present invention, the term “standard printer” is understood to be an already completely finished, commercially available device or parts thereof, as opposed to an individual custom-made design. Nevertheless, the term can also be understood to denote an in-house standardized printer, that is, also a proprietary development. In this respect, an embodiment of the invention will be described with reference to the drawing which is based on a commercially available ink-jet printer which has been developed for the consumer or semi-professional group of users and produced in large quantities. Due to this approach, considerable development costs can be saved as compared with a proprietary development which would otherwise be essential. Moreover, an approach according to the invention makes it possible to significantly reduce development effort in porting a method according to the invention from a standard printer by one manufacturer to a device by another, or to another printer model.

Two spacer elements configured in the form of punched bent parts of sheet metal are provided in an embodiment of the invention.

Particularly advantageously, the spacer element supports a printing bridge relative to at least two holding-down roller axes which are disposed, in particular, forward of and behind the printing bridge, and preferably also a rail of the drawer.

Preferably, a defined printing plane is generated progressively during the insertion of the object by smoothing the curved pages from an area of a folded seam towards the outer areas of the pages, whereby a new printing plane is generated on the upper sides of the pages.

Accordingly, a corresponding apparatus is characterized in that the apparatus has a moveable drawer which in a first final position is partially covered by a body which is configured such that during insertion of a booklet-like object it is in contact therewith over a substantially U- or V-shaped underside, the contact tapering in the insertion direction.

In a preferred embodiment of the invention, the booklet-like object is positioned by being aligned in a drawer by a guide of the longer edges of a double page opened to be imprinted. Preferably, a shorter edge is detected within the printing station by means of a print start sensor. Thereby, a particularly fast alignment and positioning is accomplished with the edges of the book being used as reference marks in a simple manner. One to about four camera systems with pattern recognition logic working independently from one another, which effect a fine adjustment of a subsequent printing process, are particularly advantageously provided. A detection of particular areas to be imprinted subsequently is thereby enabled, in particular for the purpose of finding reference points for fitting imprints as exactly as possible into predetermined areas of a page layout.

In a particularly preferred embodiment of the invention, the body with its substantially U- or V-shaped underside serves the purpose of lifting a covering mask and thus, of opening the drawer for free insertion of the booklet-like object. The covering mask serves the purpose of additionally smoothing the surface while exposing predetermined printing areas, wherein other areas are being protected from an undesired contact with ink and/or damage by pressure or transport rollers.

The wedge-shaped body has a nib in the area of its central axis which establishes a first contact between a free end edge of the covering mask and the wedge-shaped body for lifting the covering mask when the drawer is reopened.

In one embodiment of the invention, a scanner, in particular a line scanner strip, is disposed in the area of the wedge-shaped body that moves over the booklet-like object when it is inserted into the drawer. Thus, a first check as to a correct orientation, a prescribed type of booklet-like object, etc., can be performed based on image and pattern recognition already when a booklet-like object is inserted or driven in. Advantageously, no additional drives are required in this case.

In this case, the covering mask is formed as a leaf spring in one embodiment. Preferably, the covering mask is fixed to a mask holder by means of a film hinge or other solid-body joint, with the mask holder itself being supported in a longitudinally displaceable manner on the drawer. The moving distance of the covering mask is thereby restricted such that the drawer has an area that is freely accessible for the booklet-like object. In a closed state, in one embodiment of the invention, up to four pressure rollers or holding-down roller axes keep the covering mask in position above the booklet-like object and thus define a printing surface which is very smooth in at least one printing area, with close tolerances, which also make a high-quality and high-resolution print possible. In addition, the covering mask in a preferred embodiment is provided with a resilient bias so that the covering mask always lowers itself reliably into the area of the new printing plane even without the influence of holding-down rollers.

For the correct orientation of a booklet-like object in a drawer, the wedge-shaped body in another embodiment is formed to be asymmetrical such that the body is adapted for letting through a comparatively thicker half and a comparatively thinner half. If a booklet-like object is inserted backwards by 180°, a friction between the booklet-like object and the wedge-shaped body is significantly increased, which in one embodiment of the invention is used for a stop and/or ejection with a corresponding error message.

Advantageously, at least one elastic element for level compensation between the halves, which differ in height, of an opened double page of the booklet-like object is advantageously provided on the bottom of the drawer. Preferably, two elastic elements of different thickness and/or spring stiffness are being used. In one embodiment of the invention, the elastic elements are formed as rubber mats and/or resilient foam elements. A recess for a fold or hinge area is provided in a development between the level-compensating elastic elements. Advantageously, it is provided that a RFID write-read unit is embedded in at least one of the elastic elements.

In one embodiment of the invention, the elastic elements, as an aid for the operator, are prepared, for each document-half, respectively, with imprinted markings and/or labelings so that a correct positioning of a booklet-like object is unequivocally recognizable at least for a person.

In a particularly preferred embodiment of the invention, the bottom of the drawer, as an alternative or in addition to a resilience, is configured to be displaceable in the vertical direction or normal relative to the new printing plane, such that the bottom is lowered for even easier loading and is lifted when the drawer is driven into the printer. Sliding guides and/or levers can be provided for this purpose on the side of the bottom facing away from the booklet-like object.

The carriage or drawer is configured such that it can be coupled to an actual main drive of the printer. As a rule, the main drive of standard printers is configured as a friction drive. Preferably, the drawer has on an underside a friction bar coupled to the drawer via a leaf spring in order for the drawer to be controllably coupled to the main drive. Using a coupling, the friction bar can be lifted so far as to not be in contact any longer with the friction drive. In order still to be able to effect a displacement of the drawer, the coupling has rollers that are in contact with the friction bar. In a preferred embodiment of the invention, the coupling is configured as an electromagnetic coupling or a solenoid. Alternatively, a purely electric coupling in the form of a piezo actuator can be used, optionally with a lever transmission system for precisely setting a lifting distance with reduced switching times.

In order to be able to move the drawer in a defined manner when the main drive has been disengaged, a separate secondary drive is provided that can be switched on. In one embodiment of the invention, this secondary drive is formed as a belt drive, in particular using a toothed belt.

In an alternative embodiment of the invention, the friction drive or drive by a metal strip is replaced with a continuous traction drive. A required highly exact positioning is realized in particular through a toothed belt drive, as will be subsequently described with reference to illustrations of the drawings concerning exemplary embodiments.

Particularly advantageously, almost every standard printer is adaptable for configuring a printing station according to the invention by its printing bridge being arranged vertically offset by spacer elements, matching the drawer mechanism. By means of the spacer elements, the printing plane defined within the drawer underneath the printing mask is brought back in line with the distance requirements of the standard printing head. Here, the standard printer control system can advantageously be used entirely for the new printing tasks.

Advantageously, a separate control system is necessary in an apparatus according to the invention only for the separate secondary drive of the drawer and the processing of any camera signals and/or edge sensor signals. This separate control system also represents a preferred interface for other operative expansions of a printing station according to the invention, in particular a control of a RFID write-read unit. However, a correct orientation of a booklet-like object in the drawer can also be determined through pattern recognition by the camera systems, so that, even prior to the actual start of printing, an emergency stop and/or ejection with an error message can still be activated in one embodiment of the invention.

The present invention is explained below in more detail with reference to an embodiment by means of the illustrations of the drawing in order to demonstrate further advantages and features.

### BRIEF DESCRIPTION OF THE DRAWINGS

In the drawings:

FIG. 1 shows a perspective view of a printing station with the sidewall and rear wall cut away.

FIG. 2 shows a top view onto the embodiment of FIG. 1 with an opened top cover.

FIG. 3 shows a front view of the apparatus of FIG. 1 without housing.

FIG. 4 shows a perspective view of a base frame with a separate drive motor for a toothed belt drive and a version of screwed-on spacer elements in the form of massive metal parts with accommodations for the printing bridge.

FIG. 4a shows a detail of FIG. 4 in which only the drawer on the rail guide is shown with the mask fixed under three holding-down rollers.

FIG. 5 shows a three-dimensional representation of the apparatus according to FIG. 3 with a printer head/cartridge receiving means and downstream motor of a main drive shaft being omitted.

FIG. 6 shows a three-dimensional view of a portion of the apparatus according to FIG. 5 in a front view.

FIG. 7 shows a three-dimensional representation of a section in a plane A-A of the assembly according to FIG. 4.

FIG. 8 shows another three-dimensional representation of the assembly according to FIG. 5.

FIG. 9 shows a three-dimensional representation of a section through FIG. 5 for illustrating the drive in analogy to the Illustration of FIG. 7.

FIG. 10 shows a three-dimensional representation of the wedge element of FIGS. 2, 5 and 6.

FIG. 11 shows a three-dimensional representation of another embodiment of a wedge element.

FIGS. 12a and 12b show two three-dimensional representations of another embodiment of a wedge element as contained in the illustration of FIG. 4.

FIG. 13 shows a three-dimensional representation of a base frame with another embodiment of spacer elements.

FIG. 14 shows a front view of a partially sectioned printing station using the base frame of FIG. 4.

FIG. 15 is a sectional view in the plane A-A of FIG. 14.

FIG. 16 shows a detail C of FIG. 15.

FIG. 17 shows a detail D of FIG. 14.

FIG. 18 shows a three-dimensional representation of an embodiment of a drawer with two hinged plates.

FIG. 19 shows a detail A of FIG. 18.

FIG. 20 shows another three-dimensional representation of the drawer according to FIG. 18.

FIG. 21 shows a detail B of FIG. 20.

FIG. 22 shows a section through another embodiment of a drawer with resiliently supported plates.

### DETAILED DESCRIPTION OF THE PREFERRED EMBODIMENTS

Throughout the various illustrations of the drawing, the same reference numerals are used for the same elements and functional units. Without limiting the invention to this area of use, the production of security documents in the form of passports and identification documents in the form of bound small booklets or books is mainly dealt with with regard to imprinting a booklet-like object.

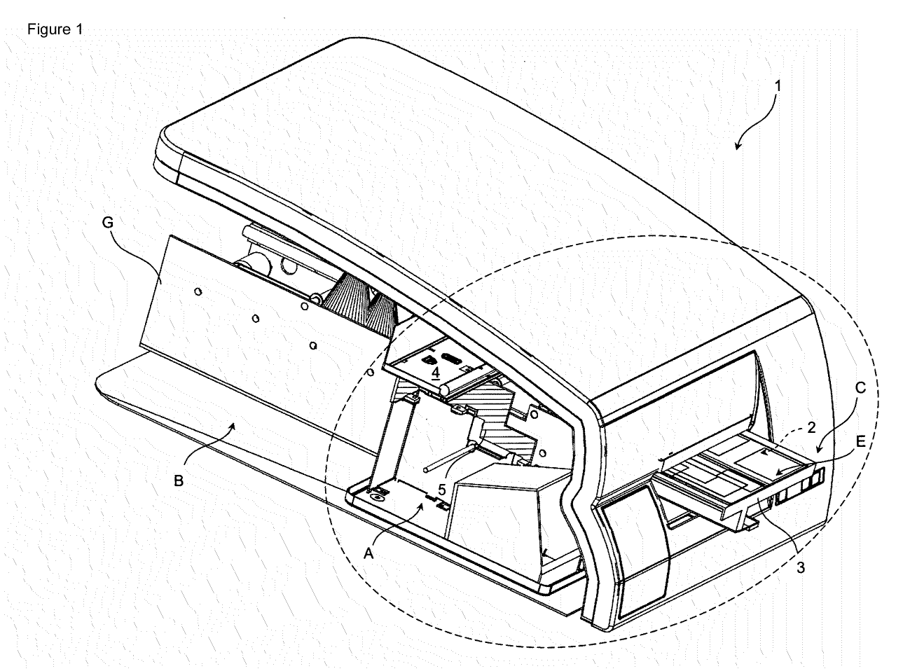

FIG. 1 shows a perspective view of a printing station 1 with the sidewall and rear wall cut away. In the present case, the printing station 1 comprises a standard ink-jet printer A and an expansion unit B with a base frame G. For inserting an opened booklet-like object 2, the actual printer A has in an insertion area E a rail-guided drawer 3 the movement of which can be controlled and monitored, at least for feeding a booklet-like object 2, by means of an operating and display panel C. In the illustration of FIG. 1, the drawer 3 is pulled out in order to be able to insert a booklet-like object 2 which is not shown in more detail.

Particularly advantageously, almost every modern standard printer is adaptable for configuring such a printing station 1 by arranging a printing bridge 4 vertically offset by spacer elements 5, matching the drawer mechanism described hereafter. By means of the spacer elements 5, the printing plane defined within the drawer 3 underneath a printing mask 6 is brought back in line with the distance requirements of a standard printing head. Here, the existing standard printer control system can advantageously be used entirely for the new printing tasks.

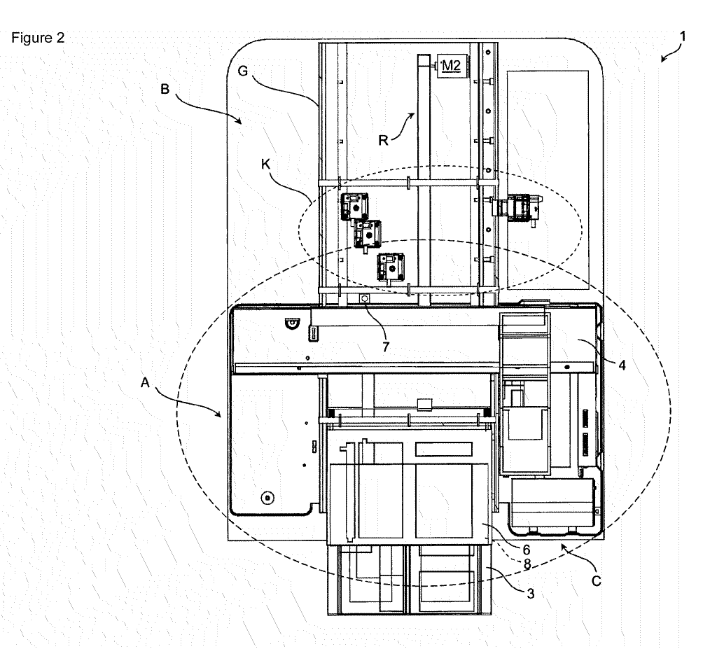

FIG. 2 is a top view onto the embodiment of FIG. 1 with an opened top cover. In it, a printing edge sensor 7 can be seen as well as a unit K comprising four camera systems and a dedicated drive M2 for the drawer 3 in the area B.

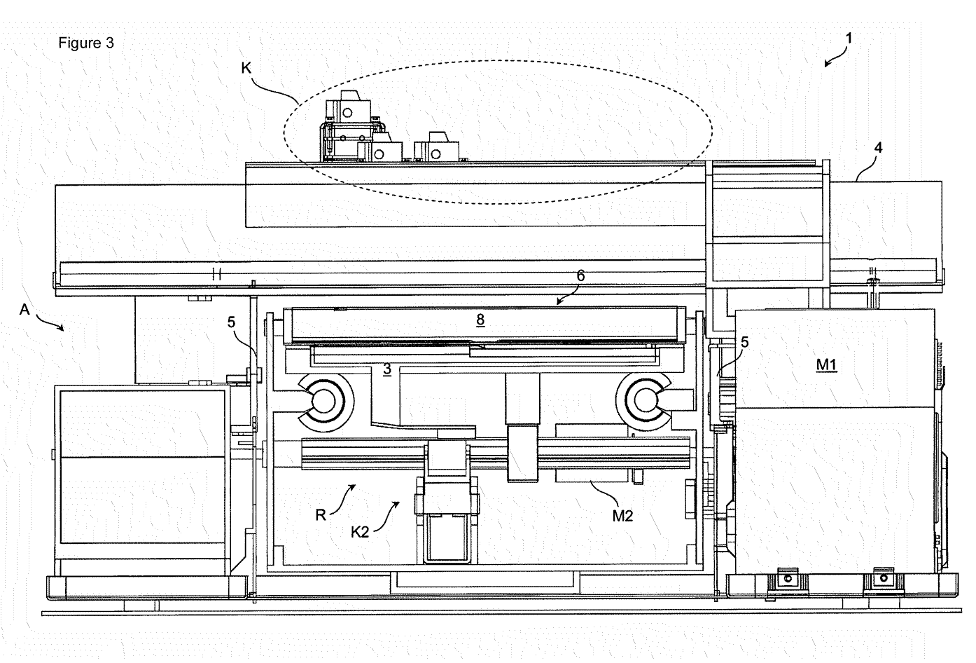

FIG. 3 shows a front view of the apparatus of FIG. 1 without housing, with a coupling K2 which controllably switches on and switches off a drive of the drawer 3 in the area A to a main drive M1 of the standard printer. The main drive M1 is rigidly coupled with a main drive shaft on the friction wheel of which the drive of the drawer 3, which is configured as a friction drive R, can be switched on and switched off.

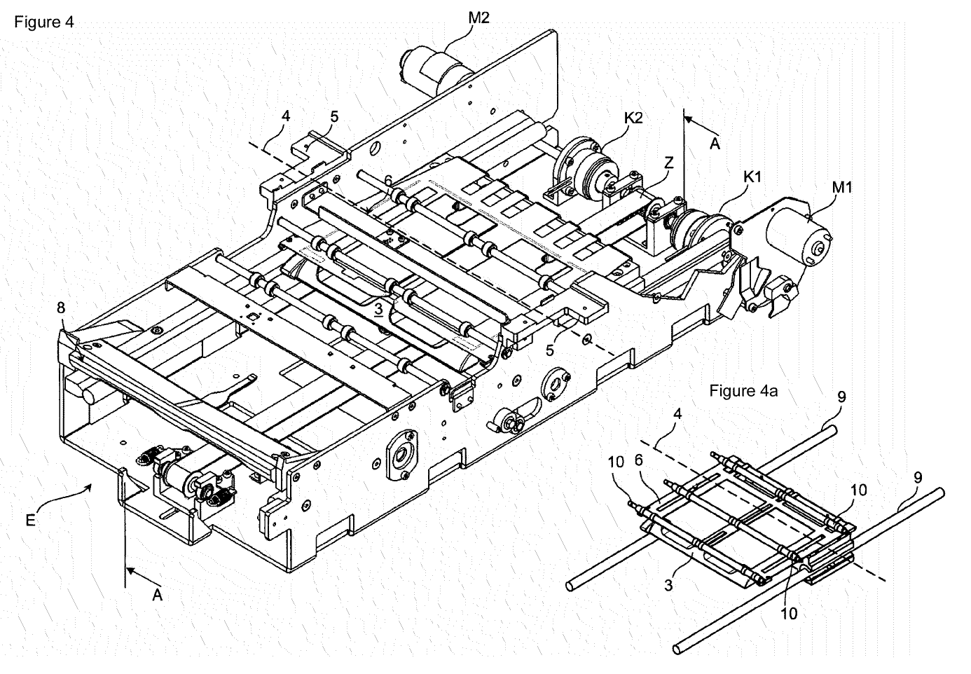

FIG. 4 shows an alternative structure of a frame G in which a toothed belt drive Z is provided for moving the drawer 3 instead of a friction disk drive. Here, as a modification of the embodiment of the FIGS. 1-3, all electric motors M1, M2 are disposed together with the associated couplings K1, K2 at an end of the frame G opposite to the insertion area E.

What both embodiments have in common is the manner of fixing a booklet-like object 2 in the drawer 3. This is explained in more detail by means of the illustration of FIG. 4a: The drawer is guided on rails 9, covered by the printing mask 6 of spring steel and would retain the booklet-like object 2 with the flat upper surfaces of the pages in the area of the printing bridge 4 so that a desired printing result could be produced. However, in order to ensure that a new printing plane is set up, the printing mask 6 is kept exactly in position precisely in the area of the printing bridge by the holding-down rollers 10. In the process, the holding-down rollers 10 are only in contact with the printing mask 6 but not with the booklet-like object 2 underneath. Soiling and smearing is thus precluded.

FIG. 5 is a three-dimensional representation of the apparatus according to FIG. 3, that is, of the printing station 1 without any external housing. The opened drawer 3 with an interior structure can now be seen well: A wedge-shaped element 8 opens the drawer 3 by holding the printing mask 6 aloft. Thus, an opened booklet-like object 2 can easily be manually inserted into the drawer 3.

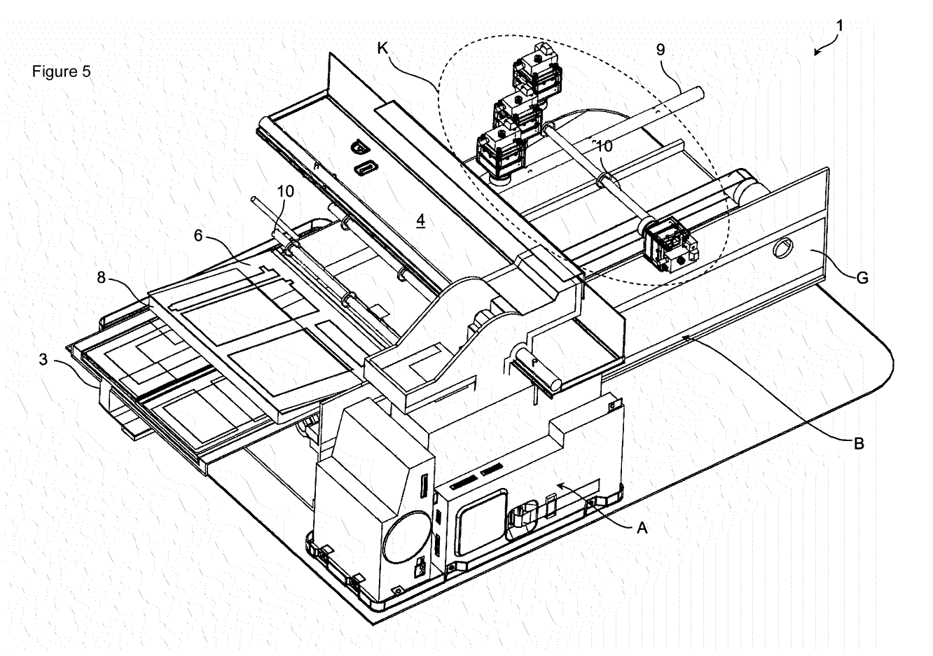

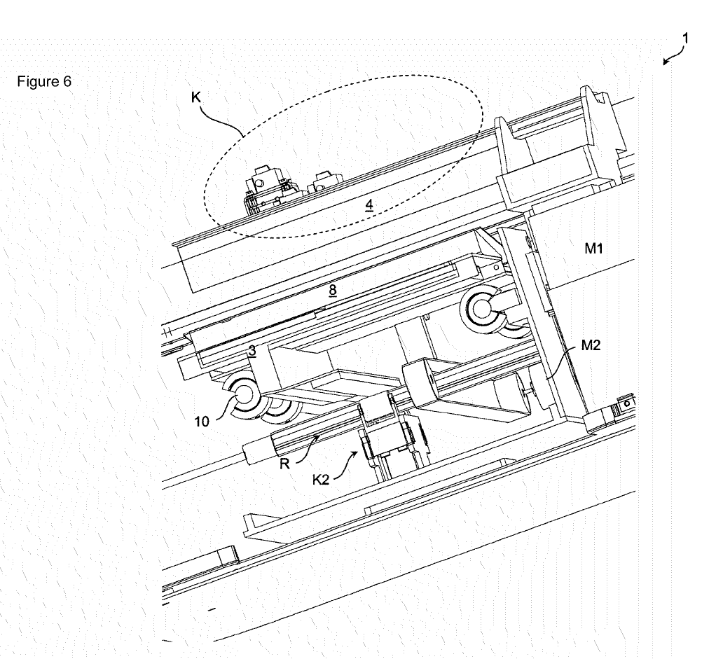

In order to illustrate the switching-on and switching-off of the actual main drive of a standard printer of known construction, FIG. 6 shows a three-dimensional view of a portion of the apparatus according to FIG. 4.

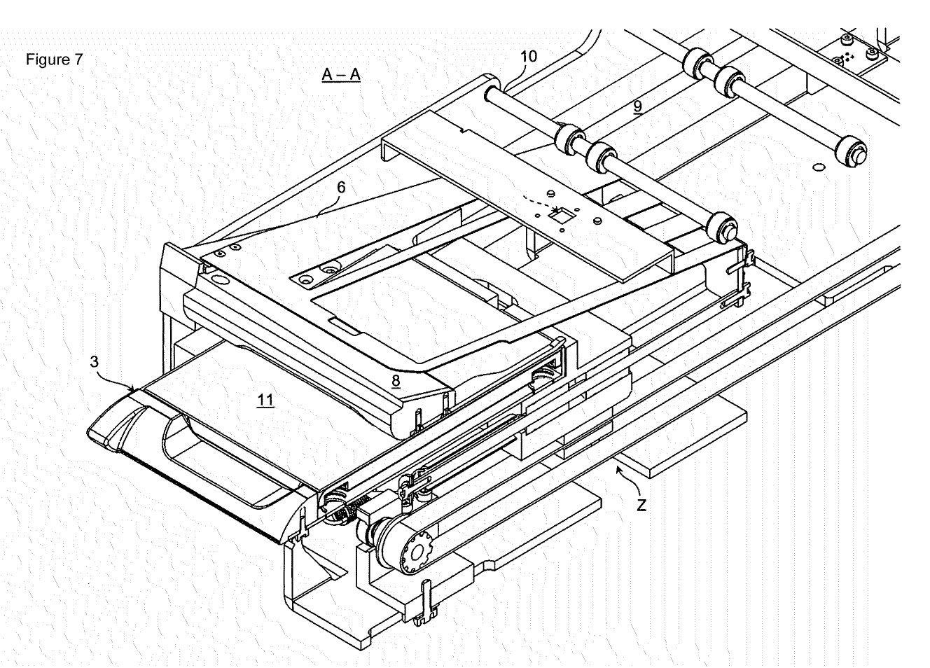

FIG. 7 is a three-dimensional representation of a section in a plane A-A of the assembly according to FIG. 4. In this opened position it becomes clear how much room there is available under the printing mask 6 above a passport pressure plate 11 resiliently supported in the drawer 3. In an embodiment of the invention which is not depicted in any more detail, the passport pressure plates 11 in the position shown are configured to be displaceable by lowering in the vertical direction or normal relative to the new printing plane for the purpose of inserting a booklet-like object 2. Thus, the bottom of the drawer in the form of the two passport pressure plates 11 is lowered for even easier loading and is lifted when the drawer is driven into the printer. Depending on the embodiment, sliding guides and/or levers can be provided on the side of the bottom facing away from the booklet-like object.

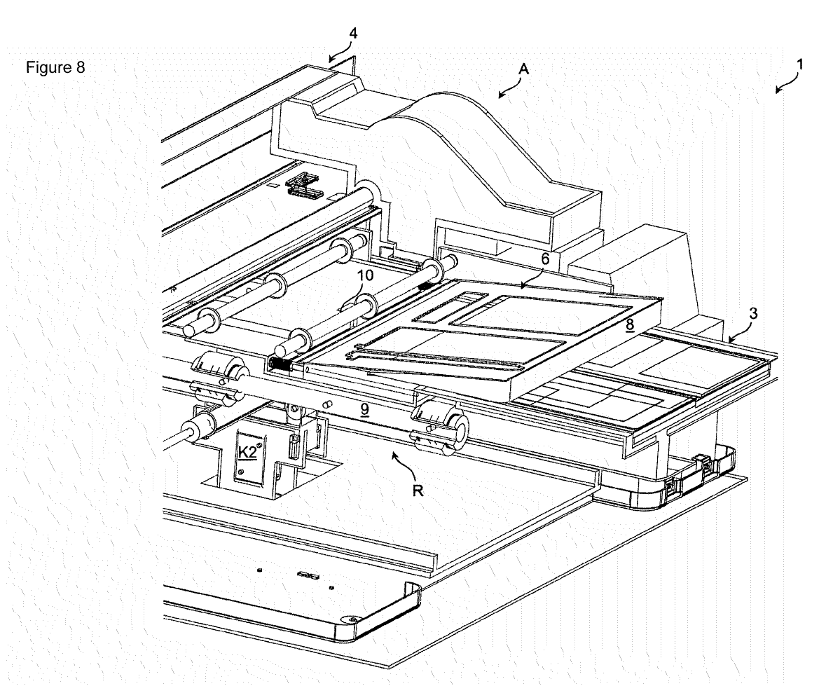

FIG. 8 is another three-dimensional representation of the assembly according to FIG. 5. Here, the main focus is on illustrating the switching on and switching off of the actual main drive of the standard printer in cooperation with moving the drawer 3 by means of its own drive, which in this case is configured as a friction drive R, the motor M2 of which, together with the coupling K2, is disposed in a rear area of the frame G of the expansion unit B, according to FIG. 2, in order to create maximum movability of the drawer 3. Accordingly, the drawer 3, using the operating panel C, is brought, by its own controller and the expansion unit B′s own drive, into a loading position for receiving an object 2.

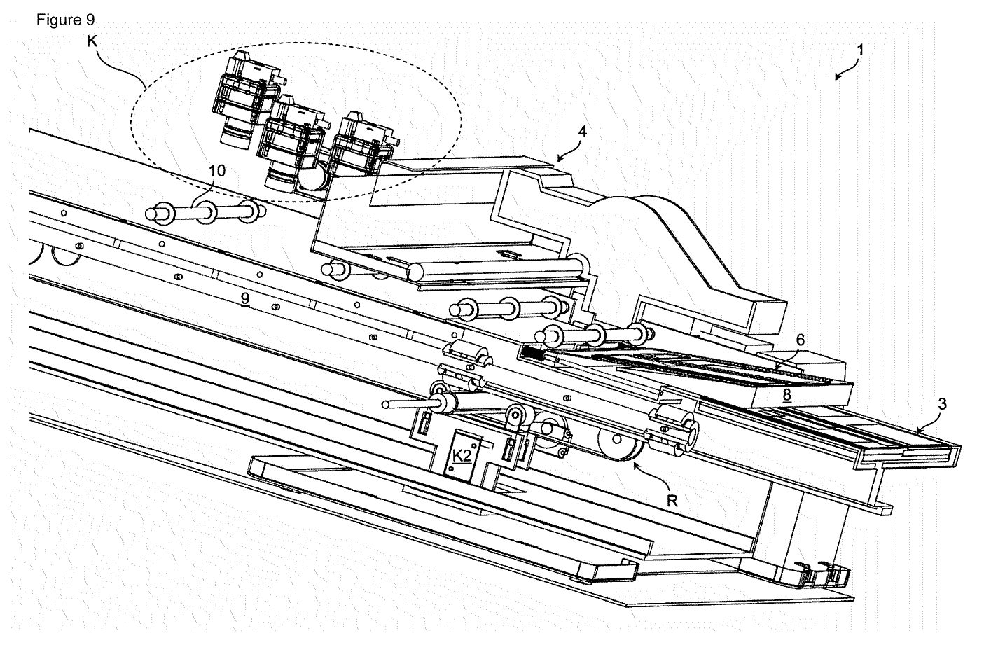

FIG. 9 shows a three-dimensional representation of a section through FIG. 5 for illustrating the drive in analogy to the Illustration of FIG. 7 in order to once again illustrate the other type of coupling the friction drive R as opposed to the belt drive Z.

In this embodiment, the drawer 3 has in its bottom part two rubber-elastic supports as passport pressure plates 11. In this form, too, the passport pressure plates 11 serve the purpose of compensating a difference in thickness between a left and a right half of a booklet-like object 2. Here, a recess for a spine or a folding joint is provided centrally, just as the passport pressure plates 11 of FIG. 7 have a recess here.

Activation of a loading sensor or manual activation in the area of the operating panel C is followed by moving the drawer 3 into a rear final position, in which a measurement is carried out by, in this case, four camera systems. The drawer is then moved until reaching the edge sensor which activates the start of the actual printing process. Thus, a switch over to the printer's own drive via a friction disk takes place again until the printing process is completed, with the print controller accepting the printing data synchronously with the drive control of the drawer 3 until the end of the printing process. Finally, the printer's own drive is then deactivated again through the coupling and the drive of the expansion unit B is coupled in for the transport of the drawer 3 into the initial position for inputting/outputting.

In the case of an electronic passport, a RFID write-read unit, which is not shown in more detail here, in the area of at least one of the passport pressure plates 11, is activated during the above described travels in order to encode an RFID chip in the object 2.

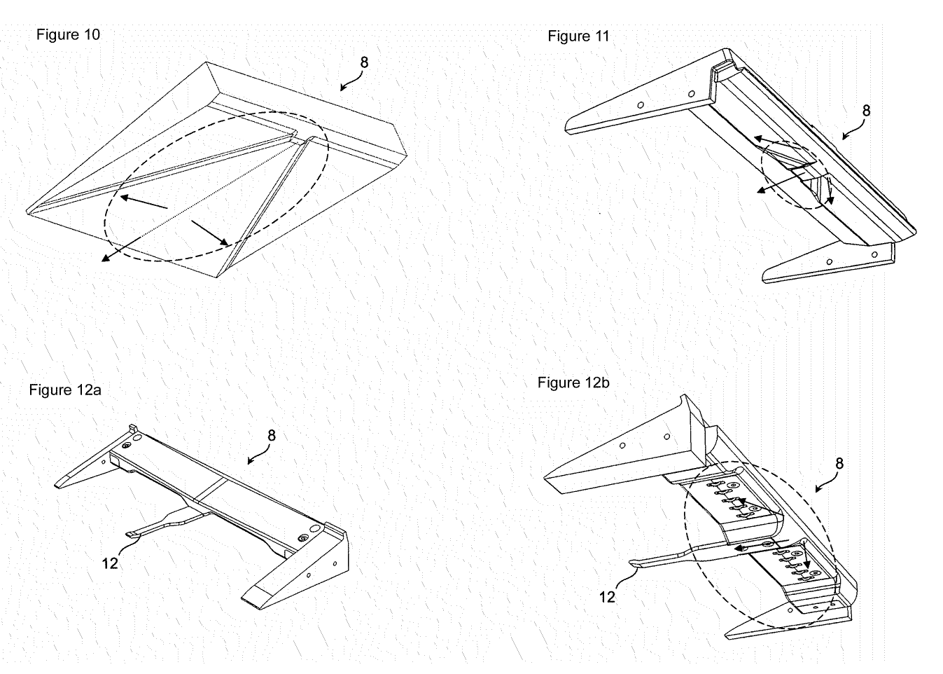

FIG. 10 is a three-dimensional representation of a wedge-shaped element 8 or wedge element with an elevation widening in a U-shape on one underside. Thereby, a defined printing plane is generated progressively during the insertion of the object 2 over the area edged in a dashed line by smoothing the curved pages from an area of a folded seam or joint towards the outer areas of the pages. The nib mentioned at the beginning for lifting the printing mask 6 for completing the process is not shown here.

FIG. 11 shows a three-dimensional representation of another embodiment of a wedge element 8. This wedge element 8 is built to be shorter than the embodiment of FIG. 10.

Two three-dimensional representations of another embodiment of a wedge element 8 constitute the illustrations of FIGS. 12a and 12b. This wedge element 8 is contained in the illustration of FIG. 4 and has a clearly recognizable nib 12 for lifting the printing mask 6. Furthermore, needle rollers are integrated in the area edged with dashed lines in order to reduce a resistance while a booklet-like object 2 is pushed in.

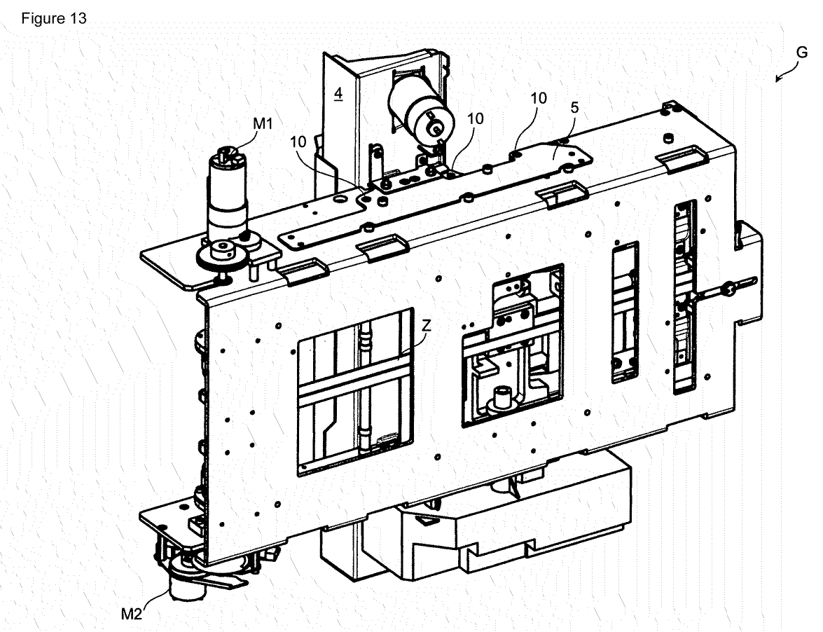

FIG. 13 is a three-dimensional representation of a base frame G with another embodiment of spacer elements 5 which are now manufactured in the form of angulated stamped bent parts of sheet metal. What is special about this spacer element 5 is that it supports a printing bridge relative to two holding-down roller axes 10, with the holding-down roller axes 10 being disposed forward of and behind the printing bridge 4. An improved precision of placement in the production results from this arrangement.

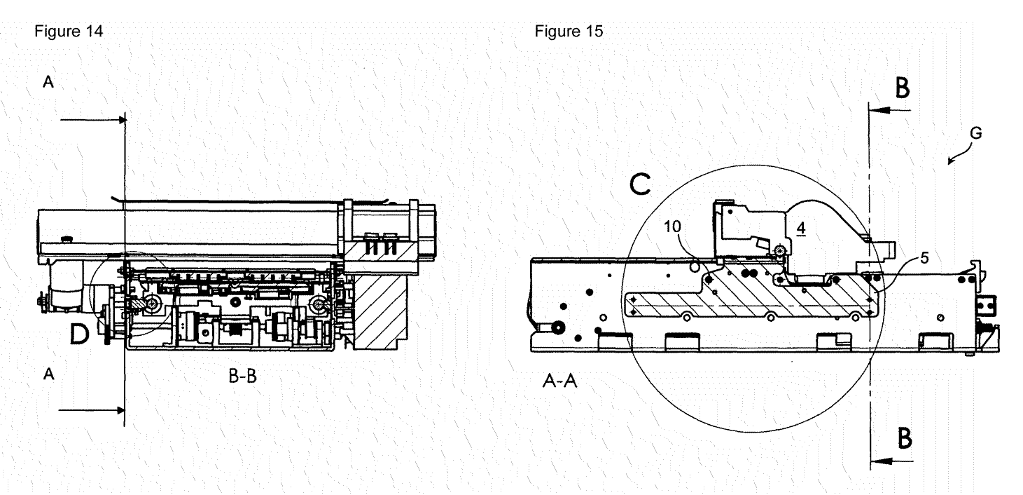

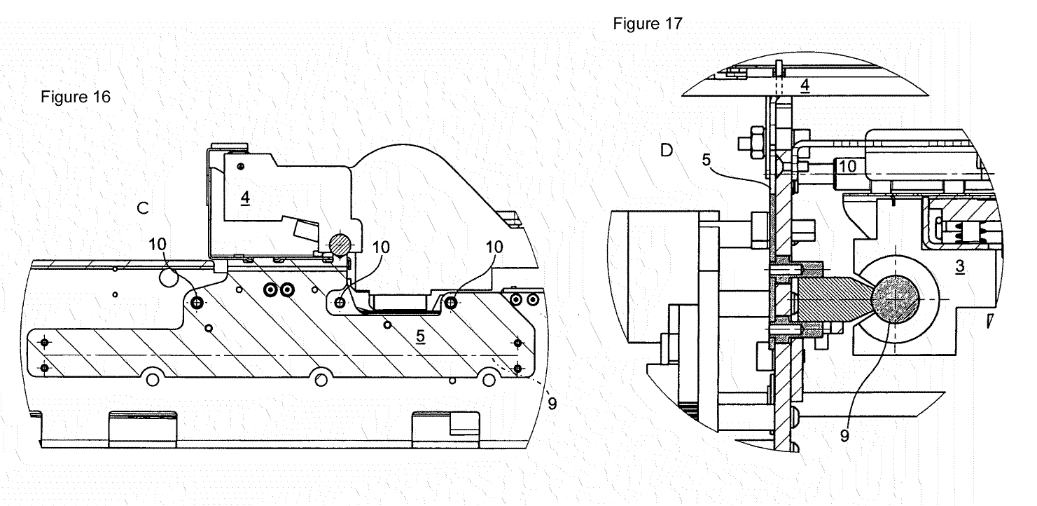

FIG. 14 shows a front view of a partially sectioned printing station 1 using the base frame G of FIG. 4 with the spacer element 5 of FIG. 13 and in the following serves orientation purposes for subsequent illustrations with sections and detailed views. Thus, FIG. 15 is a sectional view in the plane A-A of FIG. 14. Here, the above described configuration of the spacer element 5 becomes particularly clear. Based on this, FIG. 16 is a detail C of FIG. 15 which shows how an angulated upper end of the spacer element 5 engages the printing bridge 4 and also supports a running rail of a printer head separately.

FIG. 17 shows a detail D of FIG. 14. Here, an option is shown of how, by means of the spacer element 5, the rail 9 is also reliably positioned in its position relative to the holding-down rollers 10 and the printing bridge 4 by screwed connections.

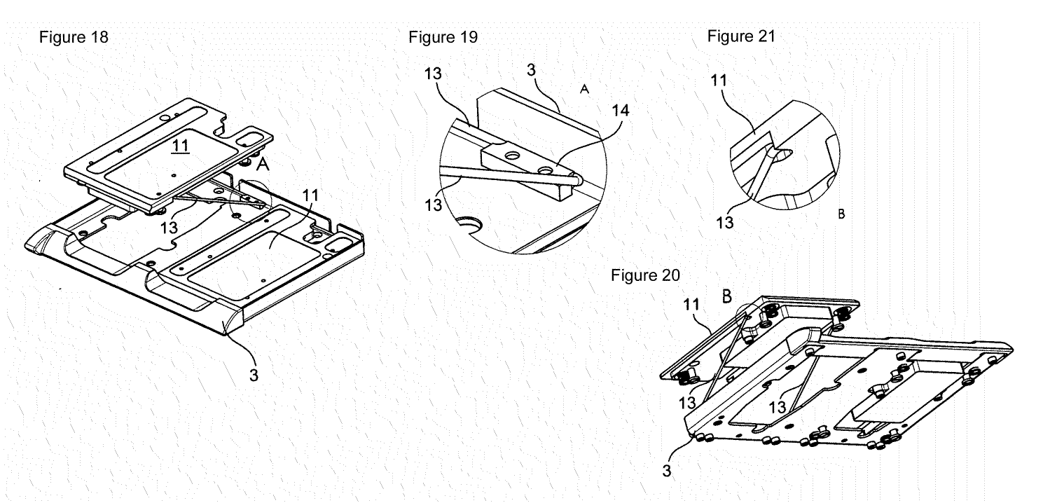

FIG. 18 shows in a three-dimensional representation an embodiment of a drawer 3 with two passport pressure plates 11 each hinged via one clip 13, respectively, as seen from above, that is, from a loading area of a booklet-like object 2. Due to the inertia of the passport pressure plates 11 and the relatively high acceleration acting on the drawer in total, this clip 13 prevents a swinging or even dancing of the associated passport pressure plate 11 which is largely without any further guidance in order to avoid jamming in the cavity of the drawer 3 supporting it, and which is only borne on four spring elements in this embodiment. As a detail A of FIG. 18, FIG. 19 shows a hinge linkage of the clip 13 on the drawer 3. Here the clip 13 partially extends under screwed-on prismatic blocks 14.

FIG. 20 is another three-dimensional representation of the drawer according to FIG. 18, now as seen from below. Here the substantially U-shaped clip 13 can be seen particularly well due to the clear spaces provided for the use of RFID transmitting and receiving units. As a detail B of FIG. 20, FIG. 21 shows a hinge linkage of the passport pressure plate 11 on the clip 13. The clip ends here by angulated end portions engaging in cavities on the passport pressure plate 11 in an articulated manner.

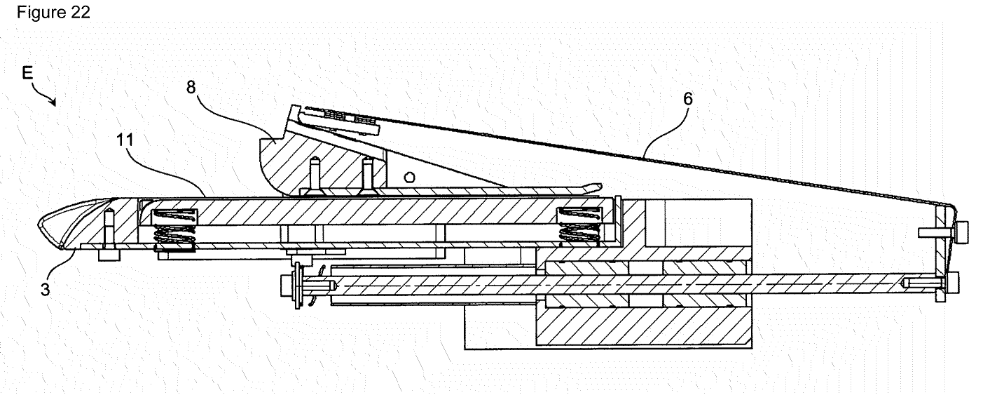

FIG. 22 shows a section through another embodiment of a drawer 3 with resiliently supported passport pressure plates 11 in an opened final position at the insertion area E. Here, the printing mask 6 has been lifted from the passport pressure plates 11 by the wedge-shaped element 8 of FIG. 12a, 12b to the extent where a booklet-like object 2 can easily be pushed between the wedge-shaped element 8 and the passport pressure plates 11 into the drawer despite the distinct resilient bias of the printing mask 6. The wedge-shaped element 8 forms a stop for the printing mask 6 due to which the printing mask 6 is pushed along its own guide away from the drawer 3 against a resilient restoring force.

Using as few proprietary parts as possible, a compact-build device has been described above which is substantially based on the clever use of existing printer structures of high-quality and fully developed standard devices. Since little metal is used an RFID write and/or reading unit can optionally be easily integrated in the area of the drawer 3 and particularly in the passport pressure plates 11.

1. A method for imprinting a booklet-like object in a printing station,
comprising:
inserting a booklet-like object in an opened state into a drawer;
feeding the booklet-like object to a printing mechanism of a standard printer;
covering the booklet-like object with a printing mask; and
pressing the booklet-like object into a new defined printing plane, using a spacer element to create the new defined printing plane.

2. The method according to claim 1, further comprising progressively generating a defined printing plane during the insertion by smoothing curved pages from an area of a folded seam towards outer areas of the pages using a body.

3. The method according to claim 1, comprising aligning the booklet-like object in a drawer using as a guide of the longer edges of a double page opened to be imprinted.

4. The method according to claim 1, comprising detecting a shorter edge of the booklet-like object within the printing station using a printing edge sensor.

5. The method according to claim 1, comprising using up to about four camera systems (K) with pattern recognition logic working independently from one another to effect a fine adjustment of a subsequent printing process.

6. The method according to claim 2, comprising using the body to lift a printing mask and thus, to open the drawer for free insertion of the booklet-like object, wherein the body has a substantially U- or V-shaped underside.

7. The method according to claim 1, wherein the drawer is driven and positioned with high precision by a friction drive, a belt drive, a metal belt, a continuous traction drive, or a toothed belt drive.

8. The method according to claim 1, comprising covering the booklet-like object in the drawer under a printing mask and pressing the booklet-like object against passport pressure plates with holding-down rollers, at least in the area of a printing bridge.

9. Apparatus for imprinting a booklet-like object in a printer with a printing bridge, with the booklet-like object, opened on a page to be imprinted, being arranged in a transport system, the apparatus comprising:
a moveable drawer in which a booklet-like object can be disposed in an opened state, wherein the drawer has a drive and control mechanism, and the drawer with its drive and control mechanism constitutes an expansion of a standard printer;
at least one spacer element that creates a defined printing plane within the drawer; and
a printing mask aligned to be pressed onto the booklet-like object, wherein the printing mask further defines the printing plane.

10. The apparatus according to claim 9, further comprising holding-down rollers that can be pressed onto the booklet-like object to create a defined smooth printing plane.

11. The apparatus according to claim 9, comprising two spacer elements that are configured in the form of punched bent parts of sheet metal.

12. The apparatus according to claim 9, wherein the at least one spacer element supports a printing bridge relative to at least two holding-down roller axes, with the holding-down roller axes being disposed, in particular, forward of and behind a printing bridge.

13. The apparatus according to claim 9, wherein a rail of the drawer is disposed on the at least one spacer element.

14. The apparatus according to claim 9, wherein the drawer, in a first final position, is partially covered by a body which is configured such that, during insertion of the booklet-like object, the booklet-like object is in contact therewith over a substantially U- or V-shaped underside of the body, the contact tapering in the insertion direction.

15. The apparatus according to claim 14, wherein the body comprises a nib for lifting the printing mask.

16. The Apparatus according to claim 9, wherein the drawer has two passport pressure plates each hinged via one clip, respectively, on the drawer.
